(19) United States
(12) Patent Application Publication
(10) Pub. No.: US 2026/0369942 A1
(43) Pub. Date: Nov. 19, 2026

(54) POWER CONNECTOR WITH IMPROVED POWER ASSEMBLIES

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/674,486

(22) Filed: May 12, 2026

(30) Foreign Application Priority Data
May 14, 2025 (CN) 202510618906.8
May 14, 2025 (CN) 202510619394.7

(51) Int. Cl. H01R 25/14

(52) U.S. Cl. CPC H01R 25/142

(57) ABSTRACT

A power connector includes: an insulating housing having a mating slot opening forward and two power assemblies; wherein: each of the two power assemblies includes a conductive plate, a conductive block, and a power extension; the conductive plate is located vertically and includes plural elastic arms extending forward and plural connecting portions, the elastic arms having contacting portions protruding into the mating slot; the conductive block has a first mounting face and a second mounting face, the first mounting face is located vertically, and the second mounting face is located horizontally; the power extension has a first flat end and a second flat end parallel to the first flat end; and the connecting portions are attached to the first mounting face of the conductive block, and the first flat end of the power extension is attached to the second mounting face of the conductive block.

### BACKGROUND OF THE INVENTION

### 1. Field of the Invention

The present invention relates to a power connector with improved power assemblies.

### 2. Description of Related Arts

U.S. Publication No. 20230155333 discloses a power connector for contacting an elongated DC bus bar and a method for monitoring such a connection. A power terminal of the connector is composed of first and second spring contact assemblies. Since high current is transmitted, temperature rise is inevitable. In order to record the temperature increase at a very early stage of electrical contact deterioration, a temperature sensor is added. However, this may not solve the problem of temperature rise.

U.S. Publication No. 20240250459 discloses a monitoring device disposed in a power connector. The rear end of the power connector transmits current through a bus bar, and the bus bar is placed vertically. However, it is not suitable for high current transmission in certain scenarios.

An improved power connector is desired.

### SUMMARY OF THE INVENTION

An object of the present invention is to provide a power connector with improved power assemblies.

To achieve the above-mentioned object, a power connector comprises: an insulating housing having a mating slot opening forward and opening in an upper-lower direction simultaneously; and two power assemblies respectively disposed on opposite sides of the mating slot in a left-right direction; wherein: each of the two power assemblies comprises at least one conductive plate, a conductive block, and at least one power extension; the at least one conductive plate is located vertically in the upper-lower direction and comprises a plurality of elastic arms extending forward and connecting portions, and the elastic arms have contacting portions protruding into the mating slot in the left-right direction; the conductive block has a first mounting face and a second mounting face, the first mounting face is located vertically in the upper-lower direction, and the second mounting face is located horizontally in the left-right direction; the at least one power extension has a first flat end and a second flat end opposite to and parallel to the first flat end; and the connecting portions of the at least one conductive plate are attached to the first mounting face of the conductive block, and the first flat end of the at least one power extension is attached to the second mounting face of the conductive block.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a power connector and a bus bar assembly before mating, wherein the power connector is mounted in an electronic device chassis;

FIG. 2 is another perspective view of the power connector mounted in the electronic device chassis in FIG. 1;

FIG. 3 is a cross sectional view taken along line A-A in FIG. 2;

FIG. 4 is a cross sectional view taken along line B-B in FIG. 2;

FIG. 5 is a perspective view of the power connector in FIG. 1;

FIG. 6 is a partially exploded perspective view of the power connector in FIG. 5;

FIG. 7 is a further exploded perspective view of the power connector in FIG. 6;

FIG. 8 is an exploded perspective view of the insulating housing and the grounding members in FIG. 7;

FIG. 9 is a perspective view of two power assemblies in FIG. 7;

FIG. 10 is another exploded perspective view of FIG. 8;

FIG. 11 is another perspective view of the two power assemblies in FIG. 9;

FIG. 12 is a perspective view of one of the two power assemblies in FIG. 9;

FIG. 13 is a partially exploded perspective view of the other power assembly in FIG. 9;

FIG. 14 is a further exploded perspective view of the power assembly in FIG. 13, with the power extensions being removed;

FIG. 15 is another exploded perspective view of FIG. 14;

FIG. 16 is a cross sectional view similar to FIG. 3, showing a modified power connector; and

FIG. 17 is a cross sectional view similar to FIG. 3, showing another modified power connector.

### DETAILED DESCRIPTION OF THE PREFERRED EMBODIMENT

Reference will now be made to the drawing figures to describe a preferred embodiment of the present invention in detail.

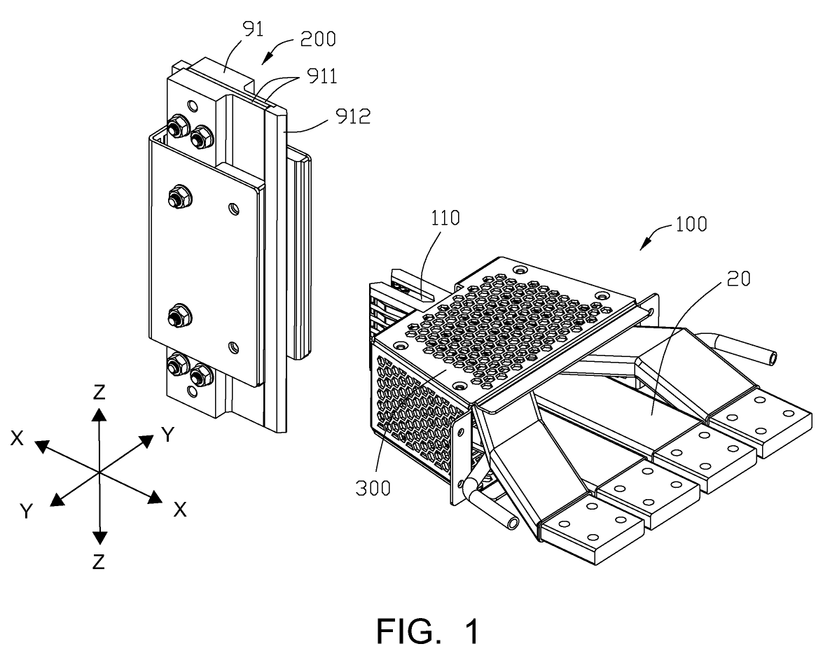

Referring to FIG. 1, a power connector 100 capable of transmitting high current is illustrated. A DC current output from a power supply unit (PSU) is transmitted to a DC bus bar assembly 200 through the power connector 100. The power connector 100 is used for mating with the bus bar assembly 200 to transmit high current. The bus bar assembly 200 includes a plug 91 loaded with negative conductors 911 and an insulating strip 912 supporting the positive and negative conductors, the two conductors are made from a bus bar. The positive and negative conductors are respectively embedded in two opposite sides of the insulating strip 912. The power connector 100 can be installed inside electronic equipment (such as a server). FIG. 1 shows a part of the electronic device chassis 300. When the plug 91 is inserted into the mating slot 110 of the power connector 100 in a mating direction X-X, the conductive plates 21 on both sides of the mating slot 110 respectively contact the positive and negative conductors 911 in a first direction Y-Y, and the high current transmission is completed through the power extensions 22 at the rear end. The mating slot 110 not only opens forward but also extends in a second direction Z-Z, facilitating the insertion of the slender plug 91.

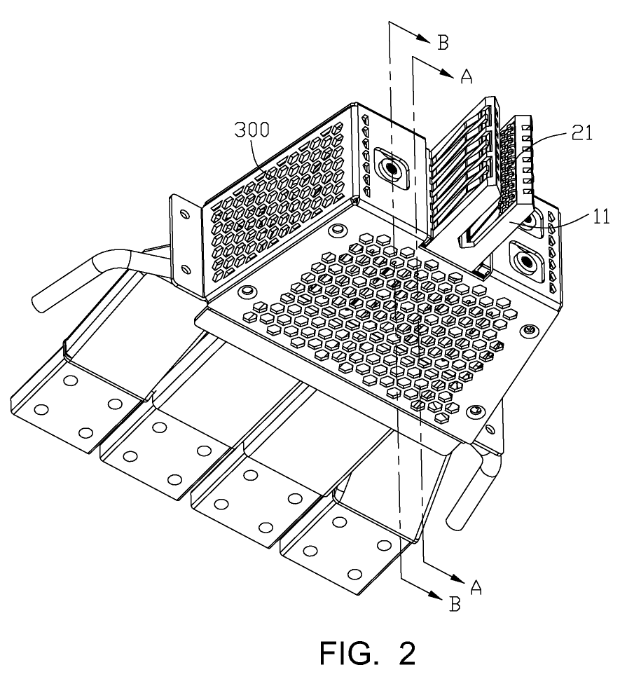

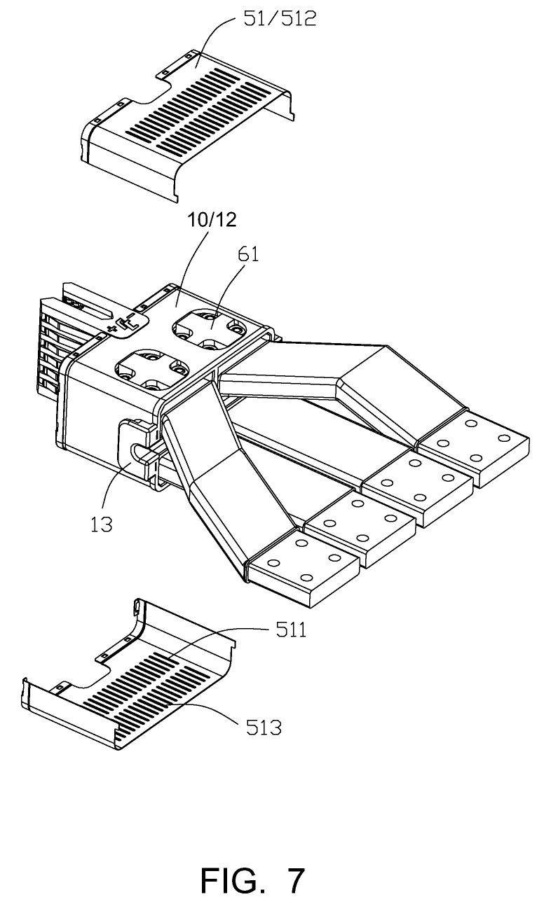

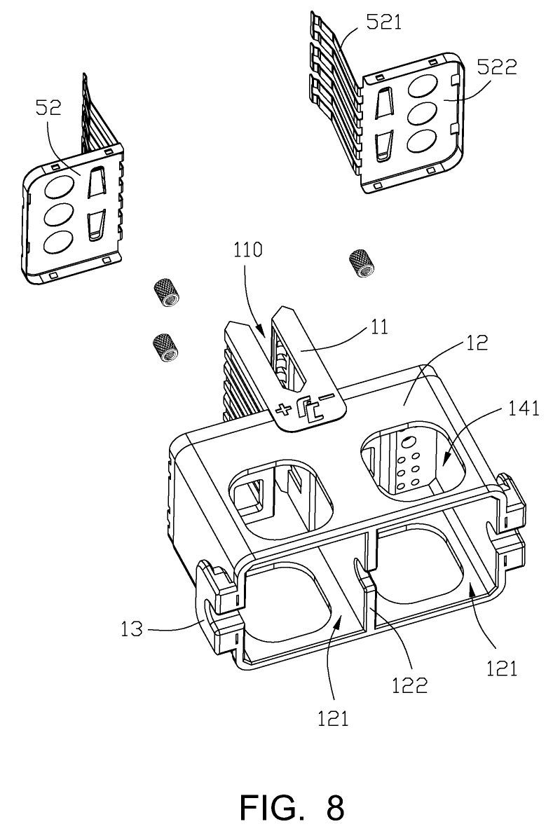

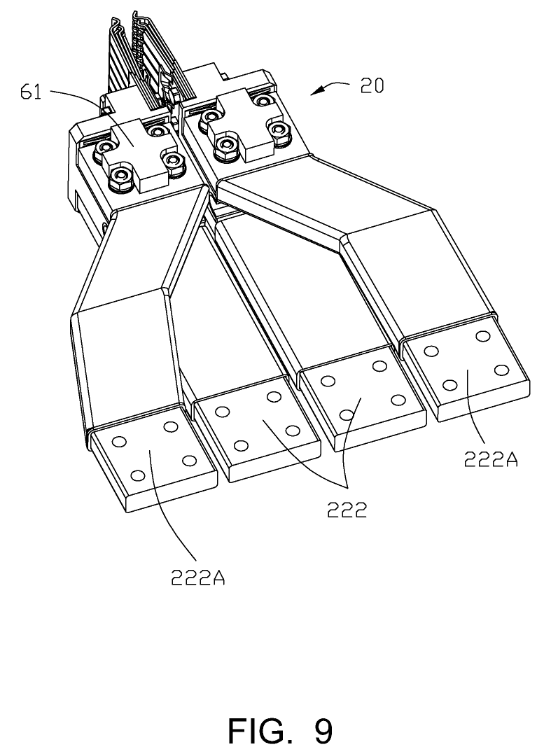

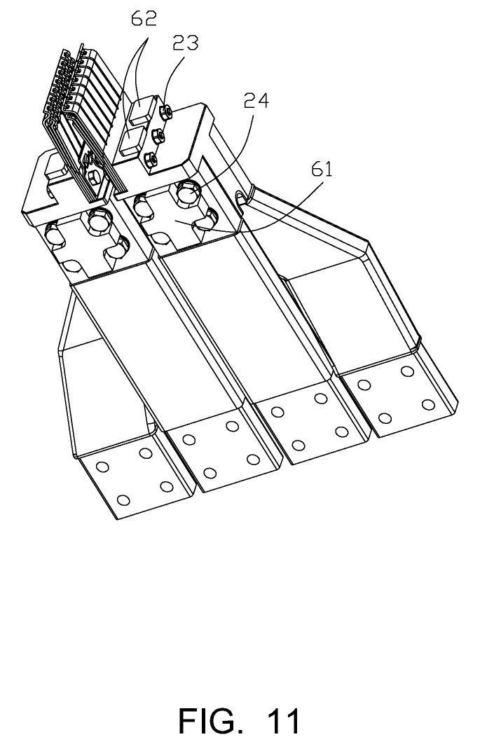

Referring to FIGS. 7-15, the power connector 100 includes an insulating housing 10 and two power assemblies 20 mounted in the insulating housing 10. The insulating housing 10 has a mating slot 110 penetrating forward in the mating direction X-X and also in the second direction Y-Y. The two power assemblies 20 are respectively disposed on opposite sides of the mating slot 110 in the first direction Y-Y. The mating direction X-X, the first direction Y-Y and the second direction Z-Z are perpendicular to each other. In this embodiment as shown in FIGS. 1-2, the first direction Y-Y is a left-right direction, and the second direction Z-Z is an upper-lower direction.

Each power assembly 20 includes at least one conductive plate 21, a conductive block 30, and at least one power extension 22. The conductive plate 21 is vertically arranged and includes a plurality of elastic arms 211 protruding forward in the mating direction X-X and a connecting portion 212. The elastic arms have contacting portions 2111 protruding into the mating slot 110 in the left-right direction. The conductive block 30 has a first mounting face 301 and a second mounting face 302, the first mounting face 301 is vertically arranged and the second mounting face 302 is horizontally arranged. Please notes, the vertical and horizontal arrangements refer to a general orientation, with small angular deviations also within the scope.

The power extension 22 includes a first flat end 221 and a second flat end 222 opposing to the first flat end. The connecting portions 212 of the conductive plate are attached and fixed to the first mounting face 301 of the conductive block, and the first flat end 221 of the power extension 22 is attached and fixed to the second mounting face 302 of the conductive block. It can be seen that the conductive plates 21 and the power extension 22 are angled via the conductive block 30, so the power extension does not need to be twisted, solving the problem where the conductive plate is vertically arranged but the second flat end is not, thus avoiding the need for the power extension to be twisted. In practical design, if the power extension is too short, it cannot be twisted, or the power extension is limited by its size, or excessive twisting causes bulging and internal stress, making the power extension stiff and less flexible.

In this embodiment, the power extension 22 extends without twisting. The power extension 22 can be a copper bar, an aluminum bar, or a copper cable with multiple copper fibers. For transmitting high current, such as up to thousands of amperes, copper bars or aluminum bars are preferred, including combinations of both. The untwisted power extension 22 also avoids the risk of wire breakage.

In this embodiment, the second flat end 222 of the power extension 22 is horizontally arranged, thereby allowing the second flat end 222 to be directly mounted on another copper bar in the electronic device.

In some embodiments, the power extension 22 is a copper or aluminum bar horizontally extending. More specifically, the outer side of the power extension is covered with an insulating protective layer 223.

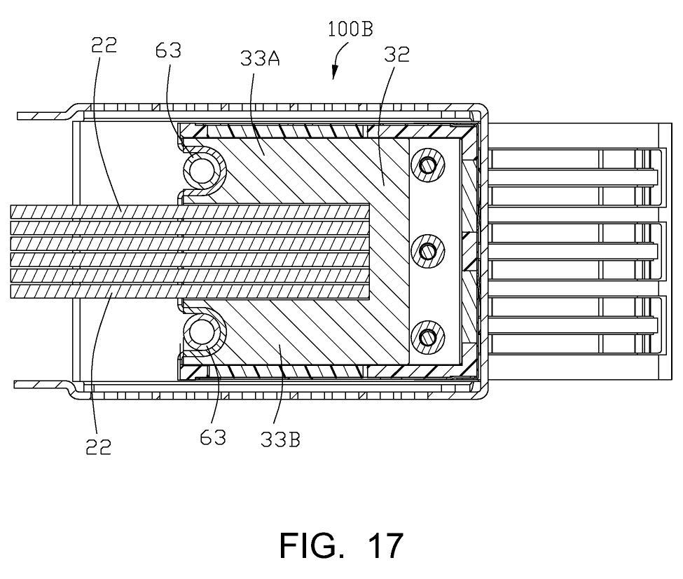

In some embodiments, the power extension 22 is formed by stacking multiple horizontally extending copper or aluminum bars. The power extension extends horizontally without twisting, allowing multiple copper or aluminum bars to be stacked, increasing the current path and reducing the risk of rapid temperature rise, as shown in FIG. 17.

In this embodiment, the at least one power extension 22 includes a first power extension 22 and a second power extension 22A. The conductive block 30 has a third mounting face 303, the third mounting face 303 is horizontally arranged and located above the second mounting face 302. The first flat end 221 of the first power extension 22 is attached to the second mounting face 302, and the first flat end 221A of the second power extension 22A is attached to the third mounting face 303. Please notes, first and second there are only for distinguishing component names, not for indicating order.

More specifically, the second flat ends 222, 222A of the two power assemblies 20 are arranged on a same horizontal plane, and the second flat ends 222 of the two first power extensions are adjacent to each other, while the second flat ends 222A of the two second power extensions are located on the left and right sides of the second flat ends 222 of the two first power extensions. Therefore, the DC output from multiple power supplies can be transferred via the second flat ends.

In this embodiment, the conductive block 30 includes a first vertical portion 31 extending in the left-right direction, a second vertical portion 32 extending forward from the first vertical portion 31 in the mating direction, and a horizontal portion 33 extending rearward from the first vertical portion 31. The second vertical portion 32 has the first mounting face 301, and the horizontal portion 33 has the second mounting face 302 and the third mounting face 303. The first flat end 221 of the first power extension is attached to the second mounting face 302, and the first flat end 221A of the second power extension is attached to the third mounting face 303. The first mounting face 301 is a vertical face orthogonal to the first direction Y-Y and the second mounting face 302 is a horizontal face orthogonal to the second direction Z-Z.

Each power assembly 20 includes a plurality of first bolt sets 23 and a plurality of second bolt sets 24. The first bolt sets 23 pass through the second vertical portion 32 and the connecting portion 212 of the conductive plate in the left-right direction to fix together. The second bolt sets 24 pass through the corresponding horizontal portion 33 and the first flat ends 221, 221A in the upper-lower direction to fix together. Each of the first bolt sets and the second bolt sets includes a bolt and a nut matched with the bolt. The bolt set further includes ring pads.

The first vertical portion 31 of the conductive block 30 has a front surface and a rear surface. The front surface of the first flat ends 221, 221A abuts the rear surface of the first vertical portion 31, and a metal elastic piece 25 is clamped between the rear surface of the first vertical portion and the front surface of the first flat end. In this embodiment, the metal elastic piece 25 has two sets of elastic beams 251 arranged in the left-right direction, each set includes multiple elastic beams 251 arranged in the upper-lower direction, each elastic beam extends horizontally and has a rearward protruding arc portion. The elastic beams 251 provide elasticity to the conductive block 30, increasing the flexible contact between the first flat ends 221, 221A and the conductive block 30, avoiding the risk of improper disconnection. Furthermore, the other four surfaces of the first flat end can each be provided with a metal elastic piece 25 to provide flexible contact, or the metal elastic piece 25 can be selectively provided on individual surfaces as needed.

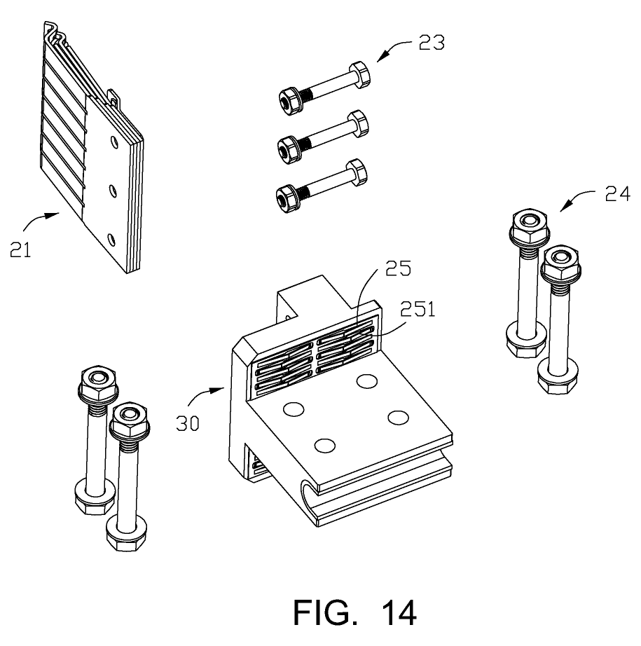

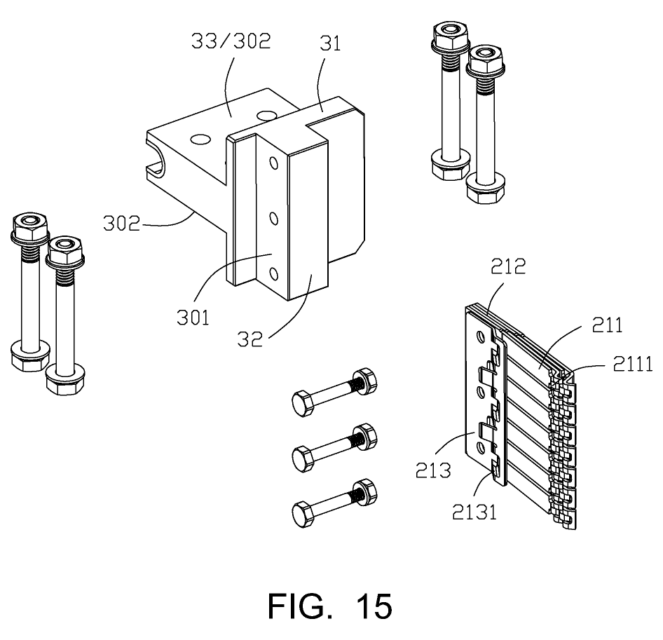

In this embodiment, the insulating housing 10 includes a base portion 12 and a mating portion 11 extending forward from the base portion 12. The mating slot 110 is defined on the mating portion 11. The base portion 12 has two receiving cavities 121 penetrating rearward and a partition wall 122 between the two receiving cavities 121. The partition wall 122 is located directly behind the mating slot 110, and the conductive block 30 and the first flat ends 221, 221A are received in the corresponding receiving cavities 121. Referring to FIGS. 14-15, each of the power assemblies 20 includes four conductive plates 21, each of the conductive plates includes a larger connecting portion 212 and plural elastic arms 211 extending from the connecting portion 212. A retaining plate 213 is fixed at an inside of the connecting portions 212, plural retaining tabs 2131 extend forward from the retaining plate and is locked with the insulating housing 10 to further retain the power assembly 20 in the receiving cavities 121.

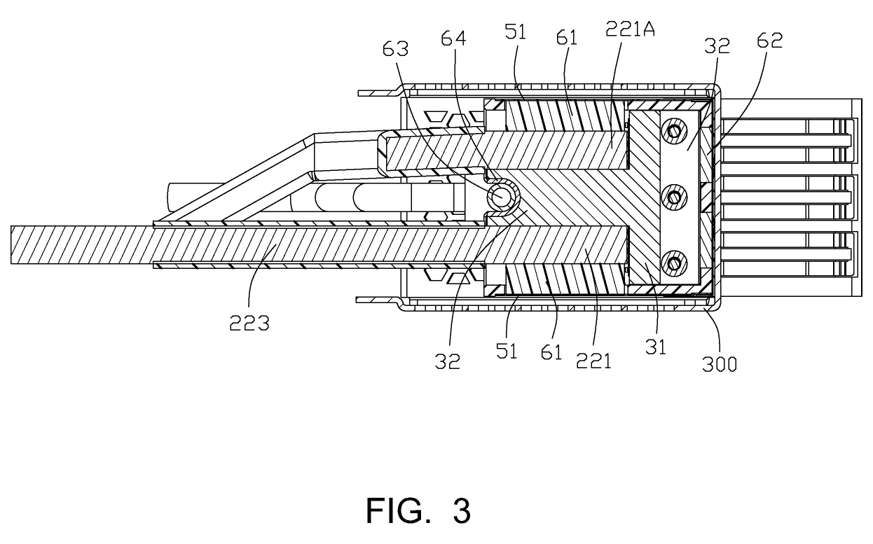

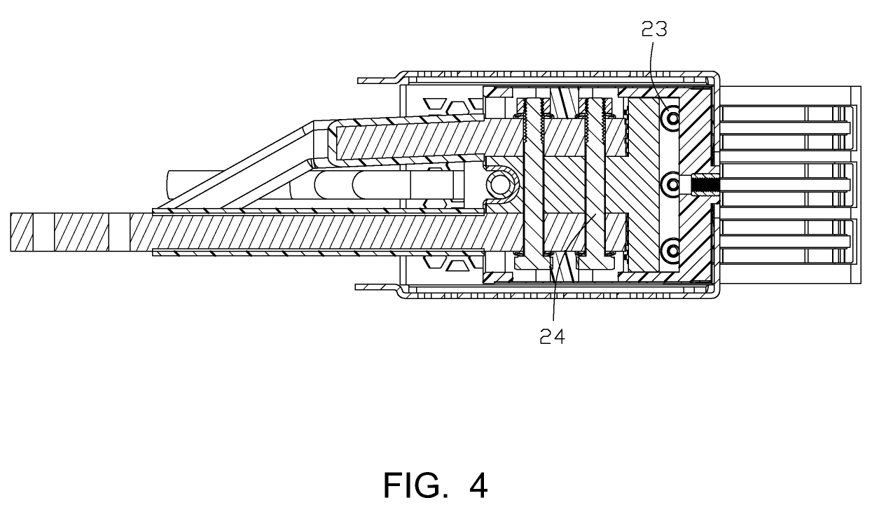

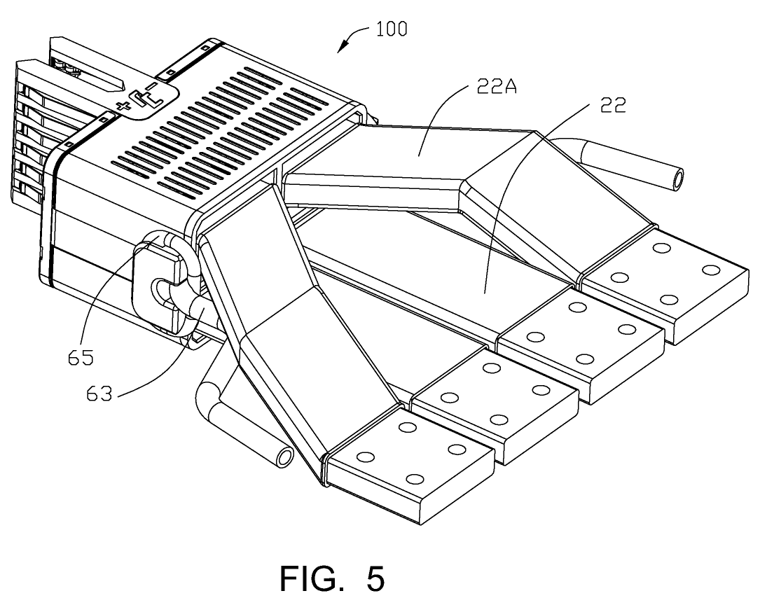

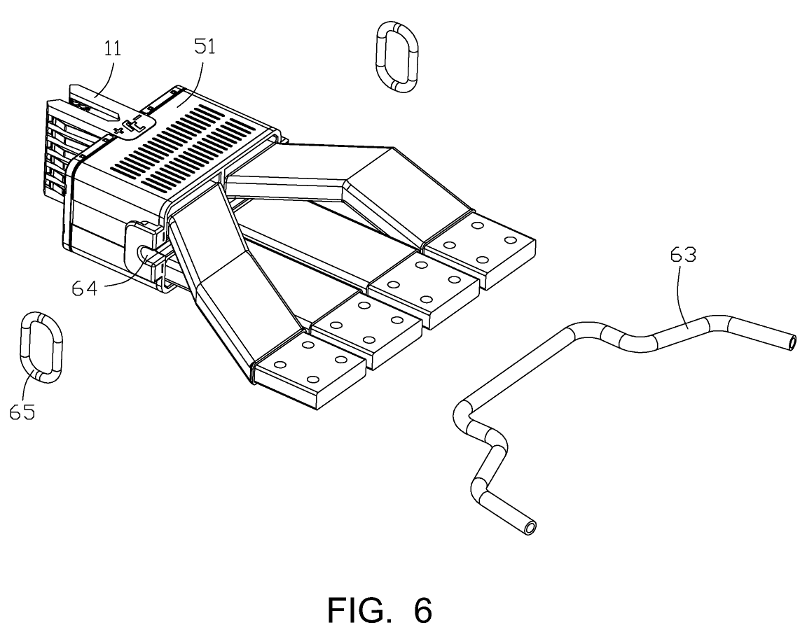

The power connector 100 of this embodiment is used to transmit high current, capable of transmitting current up to 1400A, and thus has high requirements for heat dissipation. The following describes the heat dissipation performance in more detail. Referring to FIGS. 1-13, at least one first flat end 221 of the power extension 22 is attached and fixed to the second mounting face 302 of the conductive block. The power connector 100 includes a plurality of insulating heat-conduction members 61, 62 and attached to the conductive block 30 and/or the first flat end 221, allowing internal heat to be conducted to the outside and further dissipated into the air through the electronic device chassis 300.

The power connector 100 includes a heat-dissipation pipe 63 mounted on the conductive block 30. The heat-dissipation pipe 63 can be a water-cooled heat-dissipation pipe or a copper heat-dissipation pipe, and is arranged in part areas of the conductive block to carry away the heat generated by the conductive block 30.

The rear face of the conductive block 30 has a groove (not labeled) extending in the left-right direction, and an insulating heat-conduction layer 64 is arc to match with the shape of the groove is attached inside. The heat-dissipation pipe 63 is received and attached to the insulating heat-conduction layer 64. The insulating heat-conduction layer 64 helps the heat conduction and prevents abnormal short circuits in current transmission.

The base portion 12 of the insulating housing 10 has a pair of latch portions 13, and the heat-dissipation pipe 63 is fixed to the latch portions 13 by a pair of rubber rings 65. The rubber rings 65 are used to elastically limit the heat-dissipation pipe 63.

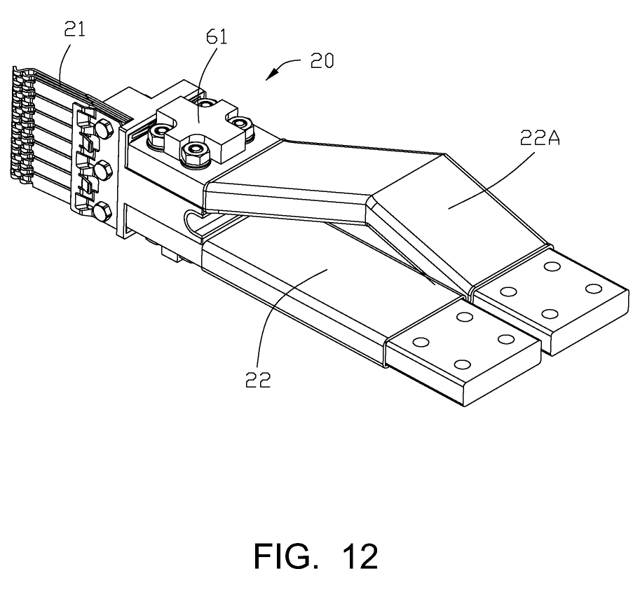

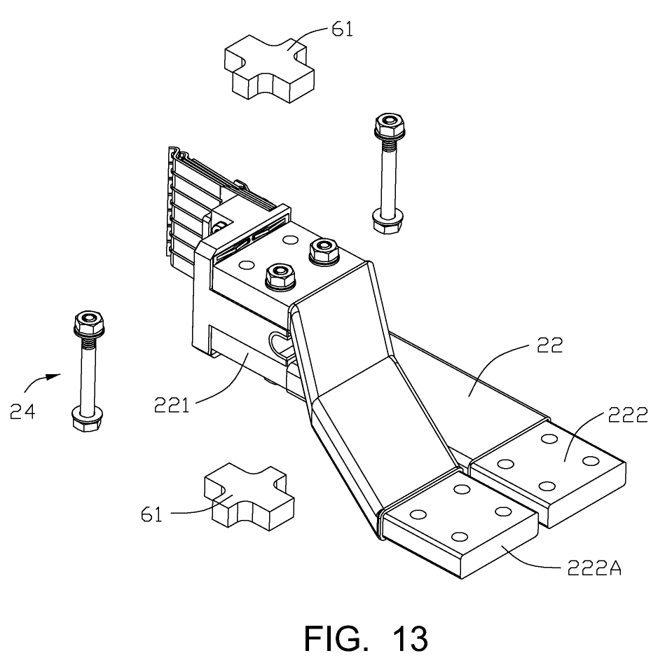

In some embodiments, the power connector 100 further includes a metal frame 51 surrounding the base portion 12 and covering the insulating heat-conduction members 61, 62, and the metal frame 51 has a plurality of heat-dissipation slits 511. The plurality of insulating heat-conduction members include a first insulating heat-conduction member 61 attached to the first flat end 221 of the power extension and passing through a first opening 141 in the base portion to contact the metal frame 51. The first insulating heat-conduction member is located and limited between the second bolt sets as best shown in FIGS. 12-13. The first insulating heat-conduction members 61 contact the metal frame 51, conducting internal heat to the outside of the power connector 100, and the metal frame 51 has the heat dissipation slits 511 to release internal heat.

The metal frame 51 includes an upper plate 512 and a lower plate 513, each has two sets of heat-dissipation slits 511 arranged in the matting direction X-X. Each heat-dissipation slit 511 extends in the mating direction. The metal frame 51 is formed by splicing U-shaped metal plates and can be assembled in the upper-lower direction.

In some embodiments, the power connector 100 further includes two grounding plates 52, the grounding plate 52 includes a base 522 attached to the front surface of the base portion 12 and a plurality of elastic grounding arms 521 attached to the outside of the mating portion 11. The base portion 12 has a plurality of second openings 142 penetrating in the mating direction. The plurality of insulating heat-conductive members include a plurality of second insulating heat-conduction members 62 attached to the front surface of the conductive block 30 and pass through the second openings 142 to contact the base 522 of the grounding plate. The second insulating heat-conduction member 62 contacts the grounding plate 52 and then the electronic device chassis 300, allowing the heat to be conducted to the external environment to aid in the heat dissipation.

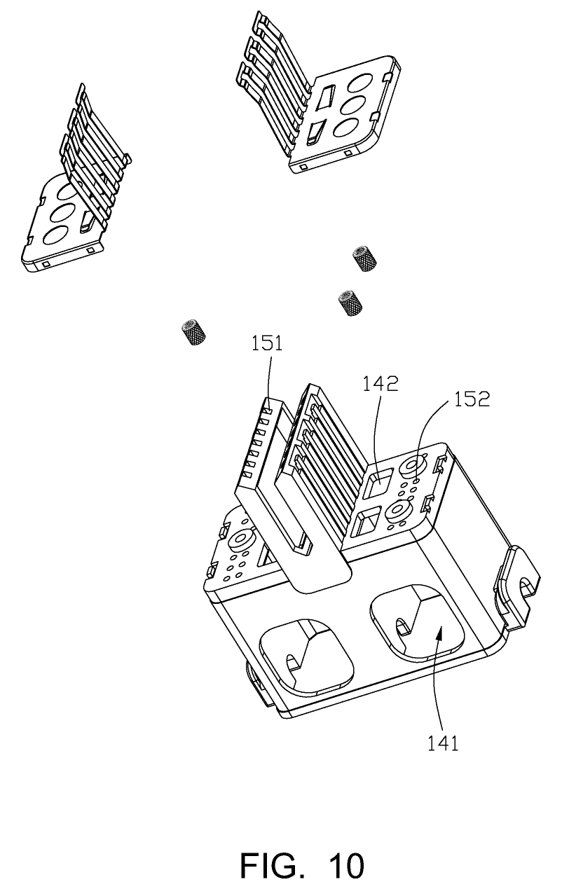

Referring to FIG. 10, the mating portion 11 of the insulating housing further has a plurality of heat-dissipation holes 151, and the base portion 12 has heat-dissipation holes 152 penetrating in the mating direction X-X, allowing heat to be dissipated.

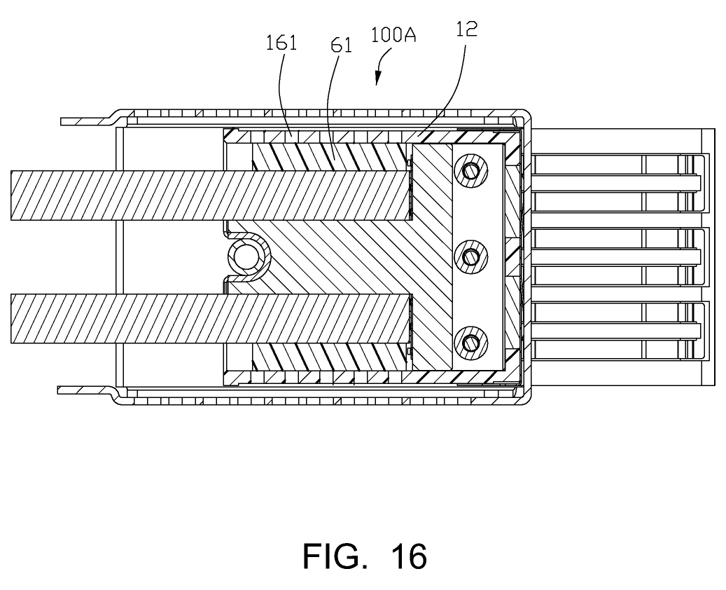

FIG. 16 shows a variant power connector 100A, the outer side of the base portion 12 has no metal frame, and the base portion 12 has a plurality of heat-dissipation channels 161. The two sides of the first insulating heat-conduction members 61 are attached between the first flat end 221 of the power extension and the base portion 12, and the heat is dissipated through the heat-dissipation channels 161.

FIG. 17 shows another variant power connector 100B, the second vertical portion 32 of the conductive block extends to form two horizontal portions 33A, 33B. The rear end of each horizontal portion 32 is assembled with a heat-dissipation pipe 63, and a plurality of power extensions 22 are arranged between the two horizontal portions.

The above-mentioned embodiments are only preferred embodiments of the present invention, and should not limit the scope of the present invention, any simple equivalent changes and modifications made according to the claims of the present invention and the contents of the description should still belong to the present invention.

1. A power connector comprising:
an insulating housing having a mating slot opening forward and opening in an upper-lower direction simultaneously; and
two power assemblies respectively disposed on opposite sides of the mating slot in a left-right direction;
wherein:
each of the two power assemblies comprises at least one conductive plate, a conductive block, and at least one power extension;
the at least one conductive plate is located vertically in the upper-lower direction and comprises a plurality of elastic arms extending forward and connecting portions, and the elastic arms have contacting portions protruding into the mating slot in the left-right direction;
the conductive block has a first mounting face and a second mounting face, the first mounting face is located vertically in the upper-lower direction, and the second mounting face is located horizontally in the left-right direction;
the at least one power extension has a first flat end and a second flat end opposite to and parallel to the first flat end; and
the connecting portions of the at least one conductive plate are attached to the first mounting face of the conductive block, and the first flat end of the at least one power extension is attached to the second mounting face of the conductive block.

2. The power connector according to claim 1, wherein the at least one power extension extends without twisting.

3. The power connector according to claim 1, wherein the at least one power extension is made of a copper bar or an aluminum bar.

4. The power connector according to claim 1, wherein:
the at least one power extension includes a first power extension and a second power extension;
the conductive block has a third mounting face horizontally arranged in the left-right direction and located above the second mounting face;
the first flat end of the first power extension is attached to the second mounting face, and the first flat end of the second power extension is attached to the third mounting face.

5. The power connector according to claim 4, wherein the second flat ends of the two power assemblies are arranged on a same horizontal plane, the second flat ends of the two first power extensions are adjacent to each other, and the second flat ends of the two second power extensions are located on left and right sides of the second flat ends.

6. The power connector according to claim 1, wherein:
the conductive block comprises a first vertical portion extending in the left-right direction, a second vertical portion extending forward from the first vertical portion, and a horizontal portion extending rearward from the first vertical portion;
the first mounting face is disposed on the second vertical portion, and the second mounting face and the third mounting face are disposed on the horizontal portion; and
at least one power extension includes a first power extension and a second power extension, the first flat end of the first power extension is attached to the second mounting face, and the first flat end of the second power extension is attached to the third mounting face.

7. The power connector according to claim 6, wherein each power assembly comprises a plurality of first bolt sets and a plurality of second bolt sets, the first bolt sets pass through the second vertical portion and the connecting portions of the conductive plate in the left-right direction to fix together, and the second bolt sets pass through the corresponding horizontal portion and the first flat end in the upper-lower direction to fix together.

8. The power connector according to claim 7, wherein the first vertical portion of the conductive block has a front face and a rear face, a front face of the first flat end abuts forwards against the rear face of the first vertical portion, and a metal elastic piece is disposed between the rear face of the first vertical portion and the front face of the first flat end.

9. The power connector according to claim 8, wherein the metal elastic piece has two sets of elastic beams arranged in the left-right direction, each set of beams includes a plurality of elastic beams arranged in the upper-lower direction, and each elastic beam extend in the left-right direction and has a rearward protruding arc portion.

10. The power connector according to claim 1 comprising a metal frame, wherein:
the insulating housing comprises a base portion and a mating portion extending forward from the base portion, the mating slot is disposed in the mating portion; and
the metal frame surrounds the base portion, and has a plurality of heat dissipation opening communicating with the base portion to an exterior.

11. A power connector comprising:
an insulating housing having a mating slot opening forwards in a mating direction;
two power assemblies respectively disposed on opposite sides of the mating slot in a first direction perpendicular to the mating direction, each power assembly comprising a plurality of conductive plates, a conductive block, and a first power extension; and
a plurality of first bolt sets and a plurality of second bolt sets;
wherein:
the plurality of conductive plates comprises a plurality of elastic arms extending in the mating direction and having contacting portions protruding into the mating slot in the first direction, and a plurality of connecting portions;
the first power extension has a first flat end and a second flat end opposite to the first flat end; and
the connecting portions are vertically attached to the conductive block by the plurality of first bolt sets inserted in the first direction, and the first flat end is horizontally attached to the conductive block by the plurality of second bolt sets inserted in a second direction perpendicular to the mating direction and the first direction.

12. The power connector according to claim 11, wherein a first insulating heat-conduction member is attached to the first flat end of the first power extension and is located among the second bolt sets.

13. The power connector according to claim 12 comprising a metal frame, wherein:
the insulating housing comprises a base portion and a mating portion extending forward from the base portion, the mating slot is disposed in the mating portion;
the metal frame surrounds the base portion, and has a plurality of heat dissipation opening communicating with the base portion to an exterior; and
the first insulating heat-conduction member passes through a first opening defined in the base portion to contact the metal frame.

14. The power connector according to claim 11, wherein a rear face of the conductive block has a groove extending in the first direction, and a heat-dissipation pipe is mounted in the groove.

15. The power connector according to claim 14, wherein an insulating heat-conduction layer is sandwiched between an inside of the groove and the heat-dissipation pipe.

16. The power connector according to claim 11, wherein a metal elastic piece is disposed between a front face of the first flat end and a rear face of the first vertical portion.

17. The power connector according to claim 16, wherein the metal elastic piece has two sets of elastic beams arranged in the first direction, each set of beams includes a plurality of elastic beams arranged in the upper-lower direction, each of the elastic beams extends in the left-right direction and has a rearward protruding arc portion.

18. The power connector according to claim 11, wherein each of the power assemblies further comprises a second power extension, a first flat end of the second power extension is attached to a second horizontal face of the conductive block locates above the first horizontal face of the conductive block.

19. A power connector comprising:
an insulating housing having a mating slot opening forwards in a mating direction; and
two power assemblies respectively disposed on opposite sides of the mating slot in a first direction perpendicular to the mating direction, each power assembly comprising a plurality of connecting portions, a plurality of elastic arms unitarily extending forwards from the connecting portions and having contacting portions protruding into the mating slot in the first direction, a conductive block having a first mounting face orthogonal to the first direction and a second mounting face orthogonal to a second direction perpendicular to the mating direction and the first direction, and a first power extension;
wherein:
the first power extension has a first flat end and a second flat end opposite to and the first flat end, and the first flat end and the second flat end are parallel to each other; and
the connecting portion is attached to the first mounting face of the conductive block, and the first flat end is attached to the second mounting face of the conductive block.

20. The power connector according to claim 19, wherein each of the power assemblies comprises a plurality of first bolt sets and a plurality of second bolt sets, the first bolt sets are inserted in the first direction to retain the connecting portions to the conductive block, and the second bolt sets are inserted in the second direction to retain the first flat end to the conductive block.
